(19) United States
(12) Patent Application Publication
(10) Pub. No.: US 2015/0126697 A1
(43) Pub. Date: May 7, 2015

(54) (METH) ACRYLIC RESIN COMPOSITION

(71) Applicant: KURARAY CO., LTD., Kurashiki-shi (JP)

(72) Inventors: Takuro Niimura, Tainai-shi (JP); Hiroyuki Konishi, Tainai-shi (JP); Hiroshi Ozawa, Tainai-shi (JP); Hidemi Kurita, Chiyoda-ku (JP); Hideyuki Tamura, Tsukuba-shi (JP)

(73) Assignee: KURARAY CO., LTD., Kurashiki-shi (JP)

(21) Appl. No.: 14/397,387

(22) PCT Filed: Apr. 22, 2013
(86) PCT No.: PCT/JP2013/002714

§ 371 Date: Oct. 27, 2014

(30) Foreign Application Priority Data
Apr. 27, 2012 (JP) 2012-103789

(51) Int. Cl. C08F 220/10

(52) U.S. Cl. CPC C08F 220/10
USPC 526/328.5

(57) ABSTRACT

A (meth)acrylic resin composition comprising 99.5% by mass or more of a (meth)acrylic resin composed of 80 to 100% by mass of a structural unit derived from methyl methacrylate and 0 to 20% by mass of a structural unit derived from an acrylic acid ester, wherein the (meth)acrylic resin composition has the rate of loss on heat of 0.5%/minute or less in a nitrogen atmosphere at 300° C., and the melt flow rate of 10 g/10 minutes or more under conditions of 230° C. and 3.8 kg load.

### TECHNICAL FIELD

The present invention relates to a (meth)acrylic resin composition. More specifically, the present invention relates to a (meth)acrylic resin composition that can give a large-area thin molded article free of silver streak at high production efficiency even by injection molding performed at a high cylinder temperature.

### BACKGROUND ART

A light guide plate as a component of a liquid crystal display is produced, for example, by injection molding of a resin composition containing a transparent resin such as a (meth)acrylic resin (see Patent Document 7). In recent years, large-area lightweight liquid crystal display devices are highly demanded and, along with this trend, large-area thin light guide plates are required.

Generally, injection molding to give a large-area thin molded article needs to be performed at a high cylinder temperature. When the cylinder temperature is high, however, thermal decomposition gas generating from the resin itself sometimes causes silver streak and/or the like to form on the resulting molded article and impairs the transparency.

In order to inhibit silver streak from forming on a molded article, Patent Document 1 suggests addition of 0.1 to 10 ppm of an organic disulfide compound to a methacrylic resin. Patent Document 2 suggests addition of a phenolic compound, for example, 2-tert-butyl-6-(3-tert-butyl-2-hydroxy-5-methylbenzyl)-4-methylphenyl acrylate, 2,4-di-tert-butyl-6-[1-(3,5-di-tert-butyl-2-hydroxyphenyl)ethyl]phenyl acrylate, or 2,4-di-tert-amyl-6-[1-(3,5-di-tert-amyl-2-hydroxyphenyl)ethyl]phenyl acrylate to a methacrylate resin. Patent Document 3 suggests addition of an organic phosphorus compound and a thioether-type organic sulfur compound to a methacrylic polymer that is obtained by copolymerization of methyl methacrylate and a maleimide compound. Patent Document 4 or 5 suggests a methacrylic polymer in which the amount of sulfur bound to the polymer is regulated to fall within the specific range. Patent Document 6 discloses that a polymerization reaction using two complete mixing tanks connected in series gives a methacrylic resin with the thermal decomposition rate regulated to fall within the specific range. Patent Document 7 discloses a methacrylic resin for light guide application characterized by comprising 90 to 99% by weight of a methyl methacrylate unit and 1 to 10% by weight of at least one alkyl acrylate unit having 1 to 8 carbon atoms in the alkyl group, MFR of 3 to 13 g/10 minutes, Vicat softening temperature of 105° C. or more, and an acid content of 50 ppm or less. Patent Document 8 discloses a resin composition that contains a copper ion at 0.005 to 3 ppm in the methacrylic resin and is excellent in thermal stability.

### PRIOR ART LIST

### Patent Literatures

Patent Document 1: JP 7-166020 A
Patent Document 2: JP 7-149991 A
Patent Document 3: JP 9-165486 A
Patent Document 4: JP 2001-172328 A
Patent Document 5: JP 2005-82716 A
Patent Document 6: JP 2004-211105 A
Patent Document 7: JP 9-31134 A
Patent Document 8: JP 8-169912 A

### Non Patent Literatures

Non-Patent Document 1: Technical data from Nippon Oil & Fats Co., Ltd. “Hydrogen abstraction capacity and efficiency as initiator of organic peroxides” (prepared on April, 2003)

### SUMMARY OF THE INVENTION

### Problems to be Solved by the Invention

These approaches thus suggested in prior art documents 1 to 7, however, have problems such as low productivity, poor appearance of the resulting molded article, inadequately controlled formation of silver streak by injection molding at high cylinder temperatures, and the like. The approach suggested in prior art document 8 is limited in its applications because of discoloration of the resulting molded article despite its improved thermal stability.

Therefore, an object of the present invention is to provide a (meth)acrylic resin composition that can give a large-area thin molded article free of silver streak at high production efficiency even by injection molding performed at a high cylinder temperature.

### Means for Solving the Problems

The inventors of the present invention conducted intensive research to achieve the object and, as a result, completed the present invention that includes the following embodiments.

[1] A (meth)acrylic resin composition comprising

99.5% by mass or more of a (meth)acrylic resin composed of 80 to 100% by mass of a structural unit derived from methyl methacrylate and 0 to 20% by mass of a structural unit derived from an acrylic acid ester, wherein

the (meth)acrylic resin composition has the rate of loss on heat of 0.5%/minute or less in a nitrogen atmosphere at 300° C., and

the melt flow rate of 10 g/10 minutes or more under conditions of 230° C. and 3.8 kg load.

[2] The (meth)acrylic resin composition according to [1], wherein the (meth)acrylic resin is composed of 80 to 96% by mass of the structural unit derived from methyl methacrylate and 4 to 20% by mass of the structural unit derived from an acrylic acid ester.
[3] The (meth)acrylic resin composition according to [1] or [2], wherein the (meth)acrylic resin is obtained by bulk polymerization.
[4] A molded article comprising the (meth)acrylic resin composition as described in any one of [1] to [3].
[5] The molded article according to [4], wherein the ratio of resin flow length to thickness is 380 or more.

### Advantageous Effects of the Invention

The (meth)acrylic resin composition of the present invention is excellent in injection moldability and therefore can give a large-area thin molded article excellent in appearance. The (meth)acrylic resin composition of the present invention can give a large-area thin molded article free of silver streak at high production efficiency even by injection molding performed at a high cylinder temperature.

### EMBODIMENTS FOR CARRYING OUT THE INVENTION

The (meth)acrylic resin composition of the present invention comprises a (meth)acrylic resin.

The (meth)acrylic resin used in the present invention comprises 80 to 100% by mass, preferably 80 to 96% by mass of a structural unit derived from methyl methacrylate relative to the total monomer units. The (meth)acrylic resin used in the present invention also comprises 0 to 20% by mass, preferably 4 to 20% by mass of a structural unit derived from an acrylic acid ester relative to the total monomer units.

Examples of the acrylic acid ester include alkyl acrylates such as methyl acrylate, ethyl acrylate, propyl acrylate, butyl acrylate, and 2-ethylhexyl acrylate; aryl acrylates such as phenyl acrylate; cycloalkyl acrylates such as cyclohexyl acrylate and norbornenyl acrylate, and the like.

The (meth)acrylic resin used in the present invention may comprise a structural unit derived from a monomer other than methyl methacrylate and an acrylic acid ester. Examples of the other monomer include non-crosslinking vinyl monomers having a single polymerizable alkenyl group per molecule, for example, alkyl methacrylates other than methyl methacrylate, such as ethyl methacrylate and butyl methacrylate; aryl methacrylates such as phenyl methacrylate; cycloalkyl methacrylates such as cyclohexyl methacrylate and norbornenyl methacrylate; and other vinyl monomers such as acrylamide, methacrylamide, acrylonitrile, methacrylonitrile, styrene, and α-methylstyrene. The amount of the structural unit derived from such monomer is preferably 10% by mass or less and more preferably 5% by mass or less relative to the total monomer units.

The weight average molecular weight (hereinafter, sometimes abbreviated as Mw) of the (meth)acrylic resin is preferably 35 thousand to 100 thousand, more preferably 40 thousand to 80 thousand, and particularly preferably 45 thousand to 60 thousand. When the Mw is too low, the molded article resulting from the (meth)acrylic resin composition tends to be less resistant to impact and less tough, while when the Mw is too high, the (meth)acrylic resin composition is less fluid and therefore tends to be impaired in its molding processability.

The ratio of weight average molecular weight/number average molecular weight (hereinafter, this ratio is sometimes expressed as molecular weight distribution) of the (meth)acrylic resin is from 1.7 to 2.6, more preferably from 1.7 to 2.3, and particularly preferably from 1.7 to 2.0. When the molecular weight distribution is low, the (meth)acrylic resin composition tends to have less molding processability, while when the molecular weight distribution is high, the molded article resulting from the (meth)acrylic resin composition tends to be less resistant to impact and therefore tends to be brittle.

The weight average molecular weight and the number average molecular weight here are molecular weights in terms of standard polystyrene measured by GPC (gel permeation chromatography).

The molecular weight and the molecular weight distribution of the (meth)acrylic resin can be controlled by selecting the kinds, the amounts, or the like of a polymerization initiator and a chain transfer agent described below.

The (meth)acrylic resin can be obtained by polymerization of a monomer mixture comprising at least methyl methacrylate and the acrylic acid ester at the mass ratios described above.

Methyl methacrylate, the acrylic acid ester and the monomers other than these, which are raw material for the (meth)acrylic resin, have the yellowness indices of preferably 2 or less, and more preferably 1 or less. When the yellowness indices of these monomers are small enough, the resulting (meth)acrylic resin composition tends to give a large-area thin molded article having little residual distortion and little discoloration at high production efficiency. As described below, a polymerization reaction for producing the (meth)acrylic resin has a moderately high polymerization conversion rate and therefore leaves an unreacted monomer in the polymerization reaction product solution. The unreacted monomer can be recovered from the polymerization reaction product solution and reused in a polymerization reaction. The yellowness index of the recovered monomer is sometimes high due to the heat applied thereto at the time of recovery and/or the like. The recovered monomer is preferably purified by a suitable method to lower the yellowness index. The yellowness index here is a value measured on colorimeter ZE-2000 manufactured by Nippon Denshoku Industries Co., Ltd. in conformity with JIS Z8722.

The polymerization reaction of the monomer mixture is performed preferably by bulk polymerization or solution polymerization, more preferably by bulk polymerization. The polymerization reaction is initiated by addition of a polymerization initiator to the monomer mixture. By adding a chain transfer agent to the monomer mixture where appropriate, the molecular weight and the like of the resulting polymer can be regulated. The amount of dissolved oxygen in the monomer mixture is preferably 10 ppm or less, more preferably 5 ppm or less, further preferably 4 ppm or less, and most preferably 3 ppm or less. When the amount of dissolved oxygen is within this range, the polymerization reaction proceeds smoothly and the resulting molded article tends to be free of silver streak or discoloration.

The polymerization initiator used in the present invention is not particularly limited provided that it generates a reactive radical. Examples thereof include tert-hexylperoxy isopropyl monocarbonate, tert-hexylperoxy 2-ethylhexanoate, 1,1,3,3-tetramethylbutylperoxy 2-ethylhexanoate, tert-butylperoxy pivalate, tert-hexylperoxy pivalate, tert-butylperoxy neodecanoate, tert-hexylperoxy neodecanoate, 1,1,3,3-tetramethylbutylperoxy neodecanoate, 1,1-bis(tert-hexylperoxy) cyclohexane, benzoyl peroxide, 3,5,5-trimethylhexanoyl peroxide, lauroyl peroxide, 2,2′-azobis(2-methylpropionitrile), 2,2′-azobis(2-methylbutyronitrile), and dimethyl 2,2′-azobis(2-methylpropionate). Among these, tert-hexylperoxy 2-ethylhexanoate, 1,1-bis(tert-hexylperoxy) cyclohexane, and dimethyl 2,2′-azobis(2-methylpropionate) are preferable.

Among these polymerization initiators, one having a 1-hour half-life temperature of 60 to 140° C. is preferable, one having a 1-hour half-life temperature of 80 to 120° C. is more preferable. As for the polymerization initiator for use in bulk polymerization, the hydrogen abstraction capacity thereof is preferably 20% or less, more preferably 10% or less, and further preferably 5% or less. The polymerization initiator can be used alone or in combination of two or more of these. The additive amount, the addition method and the like of the polymerization initiator are not particularly limited and may be selected, as appropriate, depending on the purpose that the polymerization initiator serves. The amount of the polymerization initiator for use in bulk polymerization, for example, is preferably 0.0001 to 0.02 part by mass, and more preferably 0.001 to 0.01 part by mass relative to 100 parts by mass of the monomer mixture.

The hydrogen abstraction capacity can be found, for example, in the Technical data from the manufacturer of the polymerization initiator (Non-patent Document 1, for example), or can be measured by radical trapping using an α-methylstyrene dimer, in other words, by α-methylstyrene dimer trapping. The measurement is generally carried out as follows. The polymerization initiator is cleaved in the co-presence of an α-methylstyrene dimer serving as a radical-trapping agent to give radical fragments. Among the resulting radical fragments, a radical fragment with low hydrogen abstraction capacity adds to the double bond of the α-methylstyrene dimer to be trapped by the α-methylstyrene dimer. On the other hand, a radical fragment with high hydrogen abstraction capacity abstracts hydrogen from cyclohexane to generate a cyclohexyl radical, the cyclohexyl radical then adds to the double bond of the α-methylstyrene dimer to be trapped by the α-methylstyrene dimer to give a cyclohexane-trapped product. The cyclohexane or the cyclohexane-trapped product is quantified, and the result is used to determine the ratio (molar fraction) of the amount of the radical fragment with high hydrogen abstraction capacity to the theoretical amount of radical fragment production. The ratio serves as hydrogen abstraction capacity.

Examples of the chain transfer agent include alkylmercaptans such as n-octyl mercaptan, n-dodecyl mercaptan, tert-dodecyl mercaptan, 1,4-butanedithiol, 1,6-hexanedithiol, ethylene glycol bisthiopropionate, butanediol bisthioglycolate, butanediol bisthiopropionate, hexanediol bisthioglycolate, hexanediol bisthiopropionate, trimethylolpropane tris-(β-thiopropionate), and pentaerythritol tetrakisthiopropionate; α-methylstyrene dimers; and terpinolene. Among these, monofunctional alkylmercaptans such as n-octyl mercaptan and n-dodecyl mercaptan and tetrafunctional mercaptans such as pentaerythritol tetrakisthiopropionate are preferable. The chain transfer agent can be used alone or in combination of two or more of these. The amount of the chain transfer agent used is preferably 0.1 to 1 part by mass, more preferably 0.2 to 0.8 part by mass, and further preferably 0.3 to 0.6 part by mass, relative to 100 parts by mass of the monomer mixture.

The solvent used in solution polymerization is not particularly limited provided that it is capable of dissolving the raw material monomer mixture and the resulting (meth)acrylic resin, and is preferably an aromatic hydrocarbon such as benzene, toluene, and ethylbenzene. The solvent can be used alone or in combination of two or more of these. The amount of the solvent used is preferably 0 to 100 parts by mass and more preferably 0 to 90 parts by mass relative to 100 parts by mass of the monomer mixture. As the amount of the solvent used increases, the reaction product solution becomes less viscous to give better handling but productivity tends to decrease.

The polymerization conversion rate for the monomer mixture is regulated to fall within the range of preferably 20 to 80% by mass, more preferably 30 to 70% by mass, and further preferably 35 to 65% by mass. With the polymerization conversion rate being in such a range, the rate of loss on heating and the melt flow rate are easily regulated to fall within the ranges described below. When the polymerization conversion rate is too high, stirring force required to raise the viscosity tends to be large, while when the polymerization conversion rate is too low, devolatilization tends to proceed insufficiently and the resulting (meth)acrylic resin tends to give a molded article having defective appearance such as silver streak.

Examples of the apparatus used for bulk polymerization or solution polymerization include a tank reactor equipped with a stirrer, a tube reactor equipped with a stirrer, and a tube reactor capable of stirring statically. One or more of these apparatuses may be used, or two or more of different reactors may be used in combination. The apparatus may operate in either batch-mode or continuous flow mode. The stirrer used can be selected depending on the operating mode of the reactor. Examples of the stirrer include a dynamic stirrer and a static stirrer. The most preferable apparatus to give the (meth)acrylic resin used in the present invention is one having at least one continuous-flow tank reactor. A plurality of continuous-flow tank reactors, when used, may be connected in series or in parallel.

The tank reactor usually has a stirring means for stirring liquid in the reaction tank, an inlet for supplying the monomer mixture, auxiliary materials for polymerization, and the like to the reaction tank, and an outlet for extracting the reaction product from the reaction tank. In a continuous-flow reaction, the amount of supply to the reaction tank and the amount of extract from the reaction tank are kept in balance so as to maintain approximately the same amount of liquid in the reaction tank. The amount of liquid in the reaction tank is preferably 1/4 to 3/4, more preferably 1/3 to 2/3 of the inner volume of the reaction tank.

Examples of the stirring means include a Maxblend stirring device, a stirring device in which a grid-like blade rotates about a vertical rotation axis located at the center, a propeller-driven stirring device, and a screw stirring device. Among these, a Maxblend stirring device is preferably used in terms of homogeneous mixing.

Methyl methacrylate, the acrylic acid ester, the polymerization initiator, and the chain transfer agent may be fed to the reaction tank after all of these are mixed together or may be fed to the reaction tank separately, and preferable in the present invention is feeding to the reaction tank after all of these are mixed together.

Mixing of methyl methacrylate, the acrylic acid ester, the polymerization initiator, and the chain transfer agent is preferably performed in an inert atmosphere such as in nitrogen gas. In order to allow the continuous-flow operation to proceed smoothly, it is preferable to feed methyl methacrylate, the acrylic acid ester, the polymerization initiator, and the chain transfer agent respectively from a strage tank that stores each through a tube to a mixer provided at the front of the reaction tank for continuous mixing, and then supply the resulting mixture continuously to the reaction tank. The mixer can have a dynamic stirrer or a static stirrer.

The temperature during the polymerization reaction is preferably 110 to 145° C., more preferably 120 to 140° C., and particularly preferably 125 to 135° C. When the polymerization temperature is within this range, the productivity is high and production of dimers and trimers and the number of terminal double bonds decrease to enhance the thermal stability.

The duration of the polymerization reaction in the present invention is preferably 0.5 to 4 hours, more preferably 1.5 to 3.5 hours, and particularly preferably 1.5 to 3 hours. When a continuous-flow reactor is used, the duration of the polymerization reaction is the average residence time in the reactor. When the duration of the polymerization reaction is within such a range, the melt flow rate is easily regulated to fall within the appropriate range and the thermal stability is enhanced. Polymerization is preferably carried out in an atmosphere of inert gas such as nitrogen gas.

After the completion of polymerization, an unreacted monomer and a solvent are removed where appropriate. The method for removal is not particularly limited and is preferably heat devolatilization. Examples of the method for devolatilization include the equilibrium flash process and the adiabatic flash process. Particularly in the adiabatic flash process, the temperature is preferably 200 to 280° C. and more preferably 220 to 260° C. and the heating time is preferably 0.3 to 5 minutes, more preferably 0.4 to 3 minutes, and further preferably 0.5 to 2 minutes, in devolatilization. When the devolatilization temperature and the heating time are within such ranges, production of dimers, trimers, and the like to cause heat discoloration is inhibited and therefore the thermal stability is enhanced.

The amount of the (meth)acrylic resin in the (meth)acrylic resin composition of the present invention is preferably 99.5% by mass or more and more preferably 99.8% by mass or more relative to the whole (meth)acrylic resin composition.

By regulating the yellowness indices of the raw material monomers, the amounts of substances that cause discoloration, such as unreacted monomers, dimers, and trimers in the (meth)acrylic resin, the terminal structures of the molecular chains, and the like, in the manners described above, it is possible to enhance thermal stability.

The (meth)acrylic resin composition of the present invention may also contain various additives, where appropriate, at amounts of 0.5% by mass or less and preferably 0.2% by mass or less. When the contents of the additives are too high, the resulting molded article sometimes has defective appearance such as silver streak.

Examples of the additives include an antioxidant, a thermal degradation inhibitor, an ultraviolet absorber, a light stabilizer, a lubricant, a mold release agent, a polymer processing aid, an antistatic agent, a flame retardant, a dye and a pigment, a light dispersing agent, an organic coloring agent, a delustering agent, an impact resistance modifier, and a fluorescent substance.

An antioxidant by itself has an effect to prevent oxidative degradation of a resin caused in the presence of oxygen. Examples thereof include phosphorus-based antioxidants, hindered phenol antioxidants, and thioether antioxidants. The antioxidant can be used alone or in combination of two or more of these. Among these, from the viewpoint of the effect to prevent optical properties from being impaired due to discoloration, phosphorus-based antioxidants and hindered phenol antioxidants are preferable, and the concurrent use of a phosphorus-based antioxidant and a hindered phenol antioxidant is more preferable.

When a phosphorus-based antioxidant and a hindered phenol antioxidant are concurrently used, the proportion therebetween is not particularly limited and is preferably 1/5 to 2/1 and more preferably 1/2 to 1/1 as the mass ratio of phosphorus-based antioxidant/hindered phenol antioxidant.

As the phosphorus-based antioxidant, 2,2-methylenebis(4,6-di-tert-butylphenyl)octyl phosphite (manufactured by Asahi Denka, trade name: ADK STAB HP-10) and tris(2,4-di-tert-butylphenyl)phosphite (manufactured by Ciba Specialty Chemicals, trade name: IRGAFOS 168) are preferable, for example.

As the hindered phenol antioxidant, pentaerythrityl-tetrakis[3-(3,5-di-tert-butyl-4-hydroxyphenyl)propionate] (manufactured by Ciba Specialty Chemicals, trade name: IRGANOX 1010) and octadecyl-3-(3,5-di-tert-butyl-4-hydroxyphenyl)propionate (manufactured by Ciba Specialty Chemicals, trade name: IRGANOX 1076) are preferable, for example.

A thermal degradation inhibitor can trap a polymer radical that is generated at high heat in the practical absence of oxygen and therefore can prevent thermal degradation of a resin.

As the thermal degradation inhibitor, 2-tert-butyl-6-(3′-tert-butyl-5′-methyl-hydroxybenzyl)-4-methylphenyl acrylate (manufactured by Sumitomo Chemical Company, Limited, trade name: SUMILIZER GM) and 2,4-di-tert-amyl-6-(3′,5′-di-tert-amyl-2′-hydroxy-α-methylbenzyl)phenyl acrylate (manufactured by Sumitomo Chemical Company, Limited, trade name: SUMILIZER GS) are preferable, for example.

An ultraviolet absorber is a compound capable of absorbing ultraviolet light. An ultraviolet absorber is thought to have primarily function to convert light energy into thermal energy.

Examples of the ultraviolet absorber include benzophenones, benzotriazoles, triazines, benzoates, salicylates, cyanoacrylates, oxalic anilides, malonic acid esters, and formamidines. The ultraviolet absorber can be used alone or in combination of two or more of these.

Preferable among these are benzotriazoles and ultraviolet absorbers having the maximum molar absorption coefficient εₘₐₓ at a wavelength of 380 to 450 nm of 1200 dm³·mol⁻¹ cm⁻¹ or less.

Benzotriazoles effectively inhibit optical properties from being impaired due to, for example, discoloration caused by ultraviolet radiation, and therefore are preferable as an ultraviolet absorber for use when the (meth)acrylic resin composition of the present invention is used in applications where the properties described above are required.

As the benzotriazoles, 2-(2H-benzotriazol-2-yl)-4-(1,1,3,3-tetramethylbutyl) phenol (manufactured by Ciba Specialty Chemicals, trade name: TINUVIN 329) and 2-(2H-benzotriazol-2-yl)-4,6-bis(1-methyl-1-phenylet hyl)phenol (manufactured by Ciba Specialty Chemicals, trade name: TINUVIN 234) are preferable, for example.

The ultraviolet absorbers having the maximum molar absorption coefficient εₘₐₓ at a wavelength of 380 to 450 nm of 1200 dm³·mol⁻¹ cm⁻¹ or less can inhibit yellowing of the resulting molded article. Such ultraviolet absorbers are preferable as an ultraviolet absorber for use when the (meth)acrylic resin composition of the present invention is used in applications where the properties described above are required.

The maximum molar absorption coefficient, εₘₐₓ, of an ultraviolet absorber is measured as follows. To 1 L of cyclohexane, 10.00 mg of an ultraviolet absorber is added and dissolved until no undissolved matter is visually observed. The resulting solution is poured into a quartz glass cell of 1 cm×1 cm×3 cm and the absorbance at a wavelength of 380 to 450 nm is measured by U-3410 spectrophotometer manufactured by Hitachi, Ltd. Using the molecular weight (Mw) of the ultraviolet absorber and the maximum absorbance (Aₘₐₓ) thus measured, the maximum molar absorption coefficient, εₘₐₓ, is calculated by formula:

εₘₐₓ=[Aₘₐₓ/(10×10⁻³)]×Mw.

Examples of the ultraviolet absorbers having the maximum molar absorption coefficient εₘₐₓ at a wavelength of 380 to 450 nm of 1200 dm³·mol⁻¹ cm⁻¹ or less include 2-ethyl-2′-ethoxy-oxalic anilide (manufactured by Clariant (Japan) K.K., trade name: Sanduvor VSU).

Among these ultraviolet absorbers, from the viewpoint of inhibiting degradation of a resin caused by ultraviolet radiation, benzotriazoles are preferably used.

A light stabilizer is a compound that is thought to have primarily function to trap a radical generated by light oxidation. Preferable examples of the light stabilizer include hindered amines such as compounds having a 2,2,6,6-tetraalkylpiperidine skeleton.

A mold release agent is a compound that functions to facilitate release of a molded article from a mold. Examples of the mold release agent include higher alcohols such as cetyl alcohol and stearyl alcohol; and glycerol higher fatty acid esters such as stearic monoglyceride and stearic diglyceride. The mold release agent in the present invention is preferably a combination of a higher alcohol and a glycerol fatty acid monoester. When a higher alcohol and a glycerol fatty acid monoester are used in combination, the proportion therebetween is not particularly limited and is preferably 2.5/1 to 3.5/1 and more preferably 2.8/1 to 3.2/1 as the mass ratio of higher alcohol/glycerol fatty acid monoester.

A polymer processing aid is a compound that exhibits its effect in molding a (meth)acrylic resin composition to ensure accurate thickness and give a thin product. A polymer processing aid is usually a polymer particle with a particle diameter of 0.05 to 0.5 μm that can be produced by emulsion polymerization.

The polymer particle may be a monolayer particle of a polymer having a single composition ratio and a single limiting viscosity or may be a multilayer particle of two or more polymers different in the composition ratio or the limiting viscosity. Among these, preferable examples thereof include particles having a two-layer structure where the inner layer is a polymer layer with low limiting viscosity and the outer layer is a polymer layer with high limiting viscosity of 5 dl/g or more.

The polymer processing aid preferably has limiting viscosity of 3 to 6 dl/g. When the limiting viscosity is too low, the effect to improve moldability is low, while when the limiting viscosity is too high, the melt fluidity of the (meth)acrylic resin composition tends to decrease.

The (meth)acrylic resin composition of the present invention may contain an impact resistance modifier. Examples of the impact resistance modifier include core-shell modifiers containing acrylic rubber or diene rubber as a core layer component; and modifiers containing a plurality of rubber particles.

Preferable as the organic coloring agent is a compound that functions to convert ultraviolet light, which is thought to be harmful to a resin, into visible light.

Examples of the light dispersing agent and the delustering agent include glass microparticles, polysiloxane-based crosslinked microparticles, crosslinked polymer microparticles, talc, calcium carbonate, and barium sulfate.

Examples of the fluorescent substance include fluorescent pigments, fluorescent dyes, fluorescent white dyes, fluorescent brighteners, and fluorescent bleaching agents.

These additives may be added to the polymerization reaction solution during production of the (meth)acrylic resin or may be added to the (meth)acrylic resin after produced by a polymerization reaction.

The (meth)acrylic resin composition of the present invention has the rate of loss on heat in a nitrogen atmosphere at 300° C. of 0.5%/minute or less, preferably 0.4%/minute or less, and more preferably 0.3%/minute or less. The rate of loss on heat preferably stays within this range for at least 60 minutes after the conditions of a nitrogen atmosphere and 300° C. have been established for the (meth)acrylic resin composition of the present invention.

The rate of loss on heat here is the slope of a graph on which data has been plotted, in which graph the abscissa indicates time and the ordinate indicates the proportion [%] of mass decrement from the mass at which the conditions of a nitrogen atmosphere and 300° C. have been established. In other words, the rate of loss on heat is the value defined by formula:

Rate of loss on heat[%/minute]=d/dt(W(t)).

In the formula, t denotes time, W(t) denotes the proportion [%] of mass decrement at time t from the mass at which the conditions of a nitrogen atmosphere and 300° C. have been established, and d/dt denotes differentiation of W(t) with respect to t.

The loss on heat of the (meth)acrylic resin composition of the present invention after maintained in a nitrogen atmosphere at 300° C. for 60 minutes is preferably 30% or less, more preferably 24% or less, and further preferably 18% or less.

The loss on heat can be determined by calculation by the following formula using mass W0 at the time when the conditions of a nitrogen atmosphere and 300° C. are established and mass W1 at the time when 60 minutes of mainteinance under the conditions of a nitrogen atmosphere and 300° C. is completed.

Loss on heat[%]=(W0−W1)/W0×100=ΔW/W0×100

The lower limit to the melt flow rate of the (meth)acrylic resin composition of the present invention under conditions of 230° C. and 3.8 kg load is preferably 8 g/10 minutes, more preferably 9 g/10 minutes, and further preferably 10 g/10 minutes, while the upper limit to the melt flow rate is preferably 35 g/10 minutes and more preferably 32 g/10 minutes. The melt flow rate here is a value measured in conformity with JIS K7210 under conditions of 230° C., 3.8 kg load, and 10 minutes.

As for a preferable (meth)acrylic resin composition in the present invention, YI1 is preferably 5 or less, more preferably 4 or less, and further preferably 3 or less, in which YI1 is the yellowness index for optical path length of 200 mm of an article resulting from injection molding performed at a cylinder temperature of 280° C. and a molding cycle of 1 minute.

The concentration of copper ions in a preferable (meth)acrylic resin composition in the present invention is preferably less than 0.005 ppm, more preferably not more than 0.004 ppm, and further preferably not more than 0.002 ppm. When the concentration of copper ions is within this range, the yellowness index can be regulated low.

The (meth)acrylic resin composition of the present invention can be molded by heating and melting with a method such as injection molding, compression molding, extrusion molding, and vacuum forming to give various molded articles. In particular, the (meth)acrylic resin composition of the present invention can give a large-area thin molded article free of silver streak at high production efficiency even by injection molding performed at a high cylinder temperature.

Examples of the molded article formed from the (meth)acrylic resin composition of the present invention include parts of advertising signs such as advertising pillars, sign stands, projecting signs, door-top signs, and roof-top signs; display parts such as showcases, dividers, and store display parts; lighting fixture parts such as fluorescent lamp covers, mood lighting covers, lampshades, and parts of luminous ceilings, luminous walls, and chandeliers; parts of interior furnishings such as pendants and mirrors; building parts such as doors, domes, safety window panes, partitions, stair skirting boards, balcony skirting boards, and roofs of buildings for recreational use; carrier-related parts such as aircraft windshields, pilot visors, motorcycle windshields, motorboat windshields, visors for buses, side visors for automobiles, rear visors, head wings, and headlight covers; electronics parts such as nameplates for audiovisuals, stereo covers, television protection masks, and parts of vending machines; parts of medical equipment and devices such as incubators and X-ray machines; parts related to equipment and instruments, such as machinery covers, gauge covers, parts of experiment instruments, rulers, dials, and view windows; optics-related parts such as protective plates for liquid crystal, light guide plates, light guide films, Fresnel lenses, lenticular lenses, and front plates and diffusing plates of various displays; traffic-related parts such as traffic signs, direction boards, traffic convex mirrors, and noise barrier walls; film parts such as surface materials for automotive interior, surface materials of mobile phones, and marking films; appliance parts such as lid materials and control panels of washers and top panels of rice cookers; and other items such as greenhouses, large aquariums and water tanks, box-shaped aquariums and water tanks, clock panels, bathtubs, sanitary wares, desk mats, gaming parts, toys, and welding masks for facial protection. Among these, thin injection-molded articles with a thickness of 1 mm or less are preferable and large-area thin injection-molded articles with a ratio of resin flow length to thickness of 380 or more are particularly preferable. Preferable examples of the large-area thin injection-molded articles include light guide plates.

The resin flow length here is the distance from the gate of an injection mold to the portion of the interior wall of a mold farthest from the gate. The resin flow length in an injection mold having a film gate is the distance from the portion of the injection mold where a runner and a sprue are installed to the portion of the interior wall of the mold farthest from the installation portion.

The gate of a mold for use to give the molded article according to the present invention is preferably a film gate. The film gate is fabricated by cutting with a cutter and finishing with a router and/or the like. On a mold for giving a light guide plate used in a liquid crystal display, the gate is preferably provided in the end face on which no light source is to be installed.

### EXAMPLES

The present invention will be described more specifically by examples and comparative examples. The present invention is, however, not limited to these examples. The present invention includes all the embodiments in which requirements on technical characteristics such as characteristic values, configurations, processes, and applications described above are optionally combined.

Measurement and the like of the physical properties in the examples and the comparative examples is carried out as follows.

### (Yellowness Index of Monomer Mixture)

A monomer mixture was placed in a quartz cell of 10 mm square and 45 mm long, and the transmittance for a width of 10 mm was measured on colorimeter ZE-2000 manufactured by Nippon Denshoku Industries Co., Ltd. The resulting values were used to determine XYZ values according to a method in JIS Z8722, and then yellowness index (YI) was determined by calculation according to a method in JIS K7105.

### (Polymerization Conversion Rate)

Analysis was performed on gas chromatograph GC-14A manufactured by Shimadzu Corporation to which a column, INERT CAP 1 (df=0.4 μm, 0.25 mm I.D.×60 m) manufactured by GL Sciences Inc., was connected, at an injection temperature of 180° C. and a detector temperature of 180° C., where the column temperature was set at 60° C. (maintained for 5 minutes) and was then raised at a rate of 10° C./minute to achieve 200° C. (maintained for 10 minutes). Based on this analysis, calculation was performed.

### (Measurement of Concentration of Copper Ions)

In a flask, 3 to 5 g of a (meth)acrylic resin composition was placed. The flask was heated at 400° C. to allow depolymerization to proceed until no resin was left, and was then left to cool. Thereto, 4 ml of water, 0.5 ml of sulfuric acid, and 0.5 ml of a 60% perchloric acid aqueous solution were added, followed by heating at 100° C. until no bubbles formed. The temperature was then raised to 200° C., followed by heating until the liquid became colorless. The temperature was then raised to 400° C., followed by heating for 2 hours to give a degradation residue, which was diluted with deionized water to achieve a certain volume to give an aqueous solution. The aqueous solution of the degradation residue was measured on an atomic absorption spectrometer (Hitachi model Z-8100) to calculate the concentration of copper ions in the (meth)acrylic resin composition.

### (Melt Flow Rate (MFR))

Measurement was carried out in conformity with JIS K7210 under conditions of 230° C., 3.8 kg load, and 10 minutes.

### (Loss on Heat)

A thermobalance (Shimadzu model TGA-50) was used to determine, by calculation, the rate of loss on heating and the loss on heating when the temperature was raised at a rate of 20° C./minute to 300° C. and then maintained for 60 minutes in a nitrogen atmosphere.

### (Yellowness Index (YI1))

A flat plate was made with an injection molding machine (manufactured by The Japan Steel Works, Ltd., J-110ELIII) using a mold for flat plate molding application of 200-mm long, 60-mm wide, and 6-mm thick at a cylinder temperature of 280° C. and a mold temperature of 60° C. at a molding cycle of 1 minute.

The transmittance was measured on spectrophotometer PC-2200 manufactured by Shimadzu Corporation with standard illuminant C for optical path length of 200 mm (the length of either of plates L1 and L2) at a wavelength ranging from 340 nm to 700 nm with 1-nm increments. The resulting values were used to determine XYZ values according to a method in JIS Z8722, and then yellowness index (YI) was determined by calculation according to a method in JIS K7105. The yellowness index thus calculated is called YI1.

### (Lowest Cylinder Temperature in Injection Molding and Appearance Evaluation)

Injection molding was carried out with an injection molding machine (manufactured by Sumitomo Heavy Industries, Ltd., SE-180DU-HP), with a mold for flat plate molding application of 205-mm long, 160-mm wide, and 0.5-mm thick (the ratio of resin flow length (190 mm) to thickness:380), with the cylinder temperature changed within the range of 280° C. to 320° C. by 10° C., and at a mold temperature of 75° C. and a molding cycle of 1 minute. The lowest among the cylinder temperatures at which the resulting plate had the same size as that of the mold was recorded. The plate obtained with that lowest cylinder temperature was observed by the naked eye for evaluation based on the following criteria.

A; no air bubbles (silver streak) observed,

B; silver streak observed,

C; bubbles observed all over the plate

### (Monomer Increment)

A (meth)acrylic resin composition pellet was dissolved in dichloromethane, and the resulting solution was subjected to gas chromatography to determine monomer content M0 by calculation. A flat plate obtained with the lowest cylinder temperature was dissolved in dichloromethane, and the resulting solution was subjected to gas chromatography to determine monomer content M1 by calculation. The monomer increment was calculated by formula:

Monomer increment(%)=((M1−M0)/M0)×100.

### Example 1

To an autoclave equipped with a stirrer and a sampling tube, 92 parts by mass of purified methyl methacrylate and 8 parts by mass of methyl acrylate were fed so as to prepare a monomer mixture. The yellowness index of the monomer mixture was 0.9. To the monomer mixture, 0.007 part by mass of a polymerization initiator (2,2′-azobis(2-methylpropionitrile) (AIBN), hydrogen abstraction capacity: 1%, 1-hour half-life temperature: 83° C.) and 0.43 part by mass of a chain transfer agent (n-octyl mercaptan) were added for dissolution to give a raw material solution. Nitrogen gas was used to purge oxygen gas from the production apparatus.

The raw material solution was discharged from the autoclave at a constant rate to feed a continuous-flow tank reactor controlled at a temperature of 120° C. at a constant flow rate so as to ensure the average residence time to be 120 minutes, for bulk polymerization. The reaction product solution was sampled through a sampling tube in the reactor and was measured by gas chromatography to give a polymerization conversion rate of 55% by mass.

The solution being discharged from the reactor at a constant flow rate was heated with a heater to 230° C. over 1 minute and was then fed at a constant flow rate to a twin screw extruder controlled at 250° C. In the twin screw extruder, volatile matter mainly composed of unreacted monomers was separated and removed and a resin component was extruded to obtain a strand thereof. The strand was cut with a pelletizer to give a pellet of a (meth)acrylic resin composition. The results of evaluation of the resulting (meth)acrylic resin composition are shown in Table 1.

### Example 2

The (meth)acrylic resin composition of the present invention was obtained as a pellet in the same manner as in Example 1 except that the amount of methyl methacrylate was changed intop 95 parts by mass and the amount of methyl acrylate was changed into 5 parts by mass in the monomer mixture, and the amount of n-octyl mercaptan was changed into 0.35 parts by mass. The results of evaluation of the resulting (meth)acrylic resin composition are shown in Table 1.

### Comparative Example 1

The (meth)acrylic resin composition was obtained as a pellet in the same manner as in Example 1 except that the amount of AIBN was changed in to 0.0075 part by mass, the polymerization temperature was 175° C., and the average residence time was 1 hour. The results of evaluation of the resulting (meth)acrylic resin composition are shown in Table 1.

### Comparative Example 2

The (meth)acrylic resin composition was obtained as a pellet in the same manner as in Example 1 except that the amount of methyl methacrylate was changed into 95 parts by mass and the amount of methyl acrylate was changed into 5 parts by mass in the monomer mixture, the amount of n-octyl mercaptan was changed into 0.35 part by mass, the amount of AIBN was changed into 0.0075 part by mass, the polymerization temperature was 175° C., and the average residence time was 1 hour. The results of evaluation of the resulting (meth)acrylic resin composition are shown in Table 1.

### Comparative Example 3

The (meth)acrylic resin composition was obtained as a pellet in the same manner as in Example 1 except that the amount of methyl methacrylate was changed into 99 parts by mass and the amount of methyl acrylate was changed into 1 part by mass in the monomer mixture, and the amount of n-octyl mercaptan was changed into 0.26 part by mass. The results of evaluation of the resulting (meth)acrylic resin composition are shown in Table 1.

### Comparative Example 4

The (meth)acrylic resin composition was obtained as a pellet in the same manner as in Example 1 except that 1.9×10⁻⁶ part by mass of copper (II) acetate was added to 100 parts by mass of the monomer mixture. The results of evaluation of the resulting (meth)acrylic resin composition are shown in Table 1.

### [Table 1]

TABLE 1

| | Ex. | | Comp. Ex. | | | |
|---|---|---|---|---|---|---|
| | 1 | 2 | 1 | 2 | 3 | 4 |
| [Monomer mixtrue] | | | | | | |
| Methyl methacrylate | 92 | 95 | 92 | 95 | 99 | 92 |
| [parts by mass] | | | | | | |
| Methyl acrylate | 8 | 5 | 8 | 5 | 1 | 8 |
| [parts by mass] | | | | | | |
| Monomer Yellowness index | 0.9 | 0.9 | 0.9 | 0.9 | 0.9 | 0.9 |
| [Polymerization initiator] | | | | | | |
| AIBN [part by mass] | 0.007 | 0.007 | 0.0075 | 0.0075 | 0.007 | 0.007 |
| [Chain transfer agent] | | | | | | |
| N-octyl mercaptan | 0.43 | 0.35 | 0.43 | 0.35 | 0.26 | 0.43 |
| [part by mass] | | | | | | |
| [Additive] | | | | | | |
| Copper(II) acetate | | | | | | 1.89 × 10⁻⁶ |
| [part by mass] | | | | | | |
| [Polymerization conditions] | | | | | | |
| Polymerization temperature [° C.] | 120 | 120 | 175 | 175 | 120 | 120 |
| Average residence time [hr] | 2 | 2 | 1 | 1 | 2 | 2 |
| Polymerization | 55 | 55 | 53 | 55 | 55 | 55 |
| conversion rate [%] | | | | | | |
| Evaluation of physical | | | | | | |
| properties of resin composition | | | | | | |
| Copper ion concentration [ppm] | 0.001 | 0.001 | 0.001 | 0.001 | 0.001 | 0.012 |
| Rate of loss on heat [%/min.] | 0.2 | 0.2 | 0.6 | 0.7 | 0.2 | 0.2 |
| Melt flow rate [g/10 min.] | 23 | 10 | 23 | 10 | 2 | 23 |
| YI1 | 3.0 | 4.5 | 8.1 | 9.4 | 6.7 | 11.0 |
| Lowest cylinder temperature [° C.] | 290 | 300 | 290 | 300 | 320 | 290 |
| Appearance evaluation | A | A | B | C | B | A |
| Monomer increment [%] | 0.18 | 0.33 | 0.93 | 1.42 | 0.87 | 0.17 |

As shown in Table 1, the (meth)acrylic resin composition of the present invention is excellent in injection moldability and therefore can give a large-area thin molded article free of silver streak and with excellent appearance. From above, it was proven that the (meth)acrylic resin composition of the present invention can give a large-area thin molded article free of silver streak at high production efficiency even by injection molding performed at a high cylinder temperature.

1. A (meth)acrylic resin composition comprising:
99.5% by mass or more of a (meth)acrylic resin which comprises 80 to 100% by mass of a structural unit derived from methyl methacrylate and 0 to 20% by mass of a structural unit derived from an acrylic acid ester,
wherein the (meth)acrylic resin composition has
a rate of loss on heat of 0.5%/minute or less in a nitrogen atmosphere at 300° C., and
a melt flow rate of 10 g/10 minutes or more under conditions of 230° C. and 3.8 kg load.

2. The (meth)acrylic resin composition according to claim 1, wherein the (meth)acrylic resin comprises 80 to 96% by mass of the structural unit derived from methyl methacrylate and 4 to 20% by mass of the structural unit derived from an acrylic acid ester.

3. The (meth)acrylic resin composition according to claim 1, wherein the (meth)acrylic resin is obtained by bulk polymerization.

4. The (meth)acrylic resin composition according to claim 2, wherein the (meth)acrylic resin is obtained by bulk polymerization.

5. A molded article comprising the (meth)acrylic resin composition of claim 1.

6. A molded article comprising the (meth)acrylic resin composition of claim 2.

7. A molded article comprising the (meth)acrylic resin composition of claim 3.

8. A molded article comprising the (meth)acrylic resin composition of claim 4.

9. The molded article according to claim 5, wherein a ratio of resin flow length to thickness is 380 or more.

10. The molded article according to claim 6, wherein a ratio of resin flow length to thickness is 380 or more.

11. The molded article according to claim 7, wherein a ratio of resin flow length to thickness is 380 or more.

12. The molded article according to claim 8, wherein a ratio of resin flow length to thickness is 380 or more.
